(19) United States
(12) Patent Application Publication
(10) Pub. No.: US 2024/0419863 A1
(43) Pub. Date: Dec. 19, 2024

(54) BAYESIAN OPTIMIZATION FOR MATERIAL SYSTEM OPTIMIZATION

(71) Applicant: Siemens Corporation, Washington, DC (US)

(72) Inventors: Ti-chiun Chang, Princeton Junction, NJ (US); Wenjie Yao, Monmouth Junction, NJ (US); Heng Chi, Plainsboro, NJ (US); Wei Xia, Raritan, NJ (US); Arun Ramamurthy, Plainsboro, NJ (US); Gaurav Ameta, Robbinsville, NJ (US); Reed Williams, Princeton, NJ (US)

(73) Assignee: Siemens Corporation, Washington, DC (US)

(21) Appl. No.: 18/698,563

(22) PCT Filed: Aug. 26, 2022
(86) PCT No.: PCT/US2022/041610

§ 371 Date: Apr. 4, 2024

Related U.S. Application Data
(60) Provisional application No. 63/251,876, filed on Oct. 4, 2021.

(51) Int. Cl. G06F 30/20; G06F 30/17; G06F 119/18

(52) U.S. Cl. CPC G06F 30/20; G06F 30/17; G06F 2119/18

(57) ABSTRACT

A method of optimizing a process having a plurality of potential inputs, comprising selecting a first set of inputs from the plurality of potential inputs, providing the first set of inputs from the to a first optimization process, running an objective function on the first set of inputs to produce a value corresponding to the set of inputs, providing the value to a second optimization process, running an acquisition function in the second optimization process to select a new candidate set of inputs from the plurality of potential inputs, and providing the selected new candidate set of inputs to the first optimization process. In one embodiment, the inputs are a set of lattice kernels for constructing a structural object. A Bayesian optimization is used to select sub-sets of kernels from the set of inputs. The inputs are provided to a topology optimization for evaluation.

### TECHNICAL FIELD

This application relates to optimization in design engineering.

### BACKGROUND

To develop a system for the design and optimization of structural objects, which may be as large as architectures (buildings, bridges, ships, etc.) or as small as gadgets, material design (a.k.a. the lattice structure) is critical to provide the best combination of strength, weight, and shape volumetrically throughout the designed objective. This is especially true for the increasingly popular applications of additive manufacturing. The techniques of topology optimization (TO), a mathematical method that optimizes material layout within a given design space for a given set of loads, boundary conditions, and constraints, is the method of choice for the goal of maximizing the performance of the system.

Existing topology optimization frameworks for lattice structures typically consider a small number of lattice kernels empirically determined a priori, which could lead to suboptimal designs, especially under a large number of competing design requirements. The method of multi-material topology optimization (MTO) allows for understanding and achievement of an optimal structure in the generated design space of metamaterials under a well-defined mathematical framework.

On the other hand, a recent paradigm in material design is design-by-programming (DBP). This is a way of designing physical products by means of manipulating text-based computer codes directly using the metaphors of computer programming (e.g., for loops). It has increasingly become a preferred approach to design metamaterials, which may represent complex geometries and whose properties arise from repeated structural elements (i.e., lattice kernels) with precise spacing and shape. There are practically unlimited numbers of lattice kernels which can be generated by DBP. In principle, MTO can help explore the huge design space enabled by the programmatic structure representation. However, in practice, MTO is unable to directly and simultaneously consider all the viable choices in a library of lattice kernels.

Using topology optimization to design graded lattice structures from a pre-defined library of lattice kernels has been shown to be promising for optimizing lattice structures. However, existing frameworks typically consider only one lattice kernel determined a priori empirically, which may lead to suboptimal designs, especially under a large number of design requirements.

As with any optimization that requires selection from an initial set of inputs that is large, the ability to exhaustively analyze every possible combination of inputs is constrained by the resources required to mathematically analyze each combination. Both computing resources and the time required limit the ability of a designer to consider the entire design space to select optimal designs. Solutions to more efficiently explore the design space to create optimal designs are desired.

### SUMMARY

A method of optimizing a process having a plurality of potential inputs, includes selecting a first set of inputs from the plurality of potential inputs, providing the first set of inputs from the to a first optimization process, running an objective function on the first set of inputs to produce a value corresponding to the set of inputs, providing the value to a second optimization process, running an acquisition function in the second optimization process to select a new candidate set of inputs from the plurality of potential inputs, and providing the selected new candidate set of inputs to the first optimization process.

In one embodiment, the inputs are a set of lattice kernels for constructing a structural object. A Bayesian optimization is used to select sub-sets of kernels from the set of inputs. The inputs are provided to a topology optimization for evaluation. The set of lattice kernels may be generated using design by programming (DBP). The Bayesian optimization may utilize an expected improvement function as the acquisition function for selecting a next sub-set of inputs for evaluation. To ease evaluation, the set of lattice kernels may be numerically homogenized to define a stiffness matrix for each lattice kernel. According to an embodiment, the Bayesian optimization uses a black box function to evaluate surrogate function values in a Gaussian process associated with the Bayesian optimization. In some embodiments additive noise is combined with the black box function. Operating iteratively, the Bayesian optimization begins with a first set of initial data points from the plurality of inputs to establish a prior for the Gaussian process. Then for each subsequent iteration the acquisition function is evaluated to select a next set of data points from the plurality of inputs. The Gaussian process includes a covariance matrix based on the result of the objective function representing a distance between sets of lattice kernels. The lattice space may be constructed by creating a vectorized representation of each lattice kernel as a stiffness matrix. The elements of the covariance matrix may be calculated according to an average of individual distances between elements of the sets of lattice kernels in other embodiments the covariance matrix elements are calculated as a Hausdorff distance.

In another embodiment, a computer-based system for optimizing a process having a plurality of potential inputs includes a computer processor in communication with a non-transitory computer memory, the non-transitory computer memory storing instructions that when executed by the computer processor causes the computer processor to select a first set of inputs from the plurality of potential inputs, provide the first set of inputs from the to a first optimization process, run an objective function on the first set of inputs to produce a value corresponding to the set of inputs, provide the value to a second optimization process, run an acquisition function in the second optimization process to select a new candidate set of inputs from the plurality of potential inputs, and provide the selected new candidate set of inputs to the first optimization process. The first optimization may include a topology optimization module, while the second optimization may include a Bayesian optimization module for selecting sub-sets of inputs.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a diagram of an architecture for optimizing a search of a design space according to aspects of embodiment described in this disclosure.

FIG. 2 is an illustration of a set of structural kernel inputs and resulting design according to aspects of embodiments of this disclosure.

FIG. 3 is a graphical depiction of Branin function in a 3D plot and a 2D contour plot.

FIG. 4 shows a fitting of the Branin function of FIG. 3 using 10 initial random points and after 30 iterations of a method of optimization according to embodiments of this disclosure.

FIG. 5 shows objective function minimums achieved through Bayesian optimization based on an average distance and a Hausdorff distance according to embodiments of this disclosure.

FIG. 6 is a process flow diagram for a method of optimizing a process characterized by a plurality of inputs according to embodiments of this disclosure.

FIG. 7 is a block diagram of a computer system for implementing methods and systems for optimizing a process according to aspects of embodiments of this disclosure.

FIG. 8 is an example of a library of structure inputs for use in a method of optimizing a structural element according to aspects of embodiments of this disclosure.

FIG. 9 is an illustration showing a resulting cantilever support design according to embodiments of this disclosure including the selected subset of input structures selected from the library of inputs shown in FIG. 8.

### DETAILED DESCRIPTION

Embodiments described herein include a homogenized-based multi-material topology optimization method for the design of objects, which simultaneously optimizes structural shapes and distributions of the lattice kernel types and gradation to achieve essential structural (e.g., lightweight, high-stiffness, and high-strength) and non-structural (e.g., thermal conduction) performances. Embodiments that will be described in this application include a machine learning driven multi-material topology optimization (MTO) framework which can optimize structural shape, lattice kernel type, and distributions and gradations simultaneously. An MTO module is coupled with a Bayesian optimization (BO) algorithm to efficiently search the “lattice design space” for the best set of lattice kernels to be used.

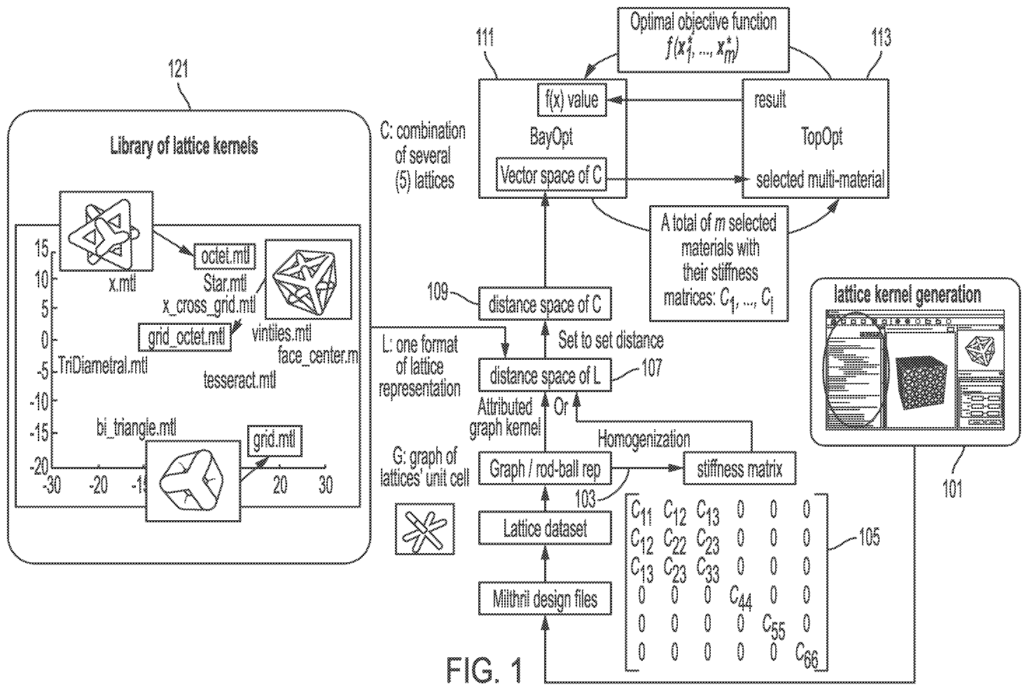

FIG. 1 illustrates a workflow according to embodiments of this disclosure. From the bottom, it starts with the file representation of the lattice kernel library 101, which is the output of a DBP system. The representation 101 goes through the numerical method of homogenization 103 to characterize each lattice kernel by a stiffness matrix 105, where distance metrics 107, 109 are specially defined. It is followed by the interaction between BO 111 and TO 113. This workflow will be described in greater detail hereinbelow.

By leveraging design-by-programming (DBP) for structural elements in the lattice kernel library 121, generation of new lattice designs are enabled that invoke further optimization by machine learning methods such as Bayesian optimization 111. Classical parametric design allows some parameters to be tuned. By contrast, when a design is embodied by text-based program code, all parts of the design can be easily varied by automatic systems. Therefore, a library 121 of a large number of different types of lattice kernels, which may be suited for different purposes, may be created. The optimal selection of a subset in the kernel library is nontrivial. For example, if 5 kernels are selected from a library of 64 candidates, there are 7,624,512 possible combinations. To find an optimal solution, it is not computationally feasible to perform an exhaustive search considering that each MTO evaluation of 5 kernels may take one hour to complete. It is reasonable to expect that this would take even longer for a typical 3D problem.

To overcome this challenge, embodiments of this disclosure formulate a BO framework. BO is frequently used to solve black-box optimization problems where the original optimization problem either does not have a close form objective function or is computationally demanding (as in the case considered here).

According to an embodiment, the BO relies on a Gaussian process (GP) to approximate an underlying black-box function f. Accordingly, it is simple to evaluate the surrogate function values modeled by GP to explore the lattice design space. BO is an iterative process, which starts with a few initial data points to construct the GP prior. During each iteration of BO, an acquisition function (AF) is utilized to suggest the next candidate location (i.e., the independent variable) where the black-box function performs an additional evaluation. Any of a number of function choices may be considered for AF. In the embodiments described herein, the expected improvement (EI) function is selected.

$$EI ( x ) = E max ( f ( x ) - f ( x + ) , 0 ) , x += arg max x \{ f ( x ) \}$$

EI allows one to optimize for the trade-off between exploitation (for better local minimizer) and exploration (for possible global minimizer valley). Once the new objective function value at the suggested location is obtained, the covariance matrix of the GP is updated. This completes one iteration of BO.

The standard Bayesian optimization assumes the search region to be smooth with a metric that defines proximity. For example, for X ⊂ [symbol] ^{d}, a scalar black-box function f is evaluated in the presence of additive noise e such that y=ƒ(x)+e for x∈X.

For this discussion, the domain to the TO module is chosen to be the representation of the sets of the lattice kernels, denoted as Ω. The process of lattice space construction builds a vectorized representation of lattice kernels such that the Bayesian optimization module may leverage topology optimization to efficiently explore distinct combinations of lattices required to sustain the dynamic loads as observed by the design objective. This representation of stiffness matrices is derived from homogenizing the lattice parameters (e.g., shape and orientation) from a macroscale perspective. The search space is designed to be directly the domain Ω, because the option of a latent space for Ω requires an objective function to optimize (or train), which can complicate the formulation. In either case, two challenges exist. 1. How to define a distance metric between two lattice kernels and. 2. How to define a distance metric between two sets of lattice kernels. Therefore, a Bayesian optimization must operate on the domain of (sub-) sets of the lattice kernels.

Before defining the metrics, the notations used in the description are identified as follows. The search region is a collection of (non-redundant) sets Xₛₑₜ={{Xᵢ_{ⱼ}|i=1, . . . , I,j ∈{1, . . . , K}}^{m}|m=1, . . . , M}, Xᵢ_{ⱼ} ∈ [symbol] ^{d}} where K is the number of kernels in the lattice library; I is the number of the inputs lattice kernels to the TO module; and M=|Xₛₑₜ|=(_{I}^{K}), is the number of all the possible sets. Further, X\hat{ }m is used to denote the mth set in X_set as a simplified notation for the input to the TO module, which is essentially the set of flattened stiffness matrices. Thus, our formulation of the black-box function, i.e., TO module, is: y=ƒ(X^{m})+e. We will train BO with pairs of data (Xⁿ, yₙ), n=1, . . . , N, N<<M.

Now, a definition of the distance between two sets of lattice kernels is presented along with the process for calculating the elements of the covariance matrix of GP as:

$${k}_{set} ( {X}^{m} , {X}^{n} ) = k ( \frac{1}{\vert {X}^{m} \vert \vert {X}^{n} \vert} {\sum }_{i 1 = 1}^{I} {\sum }_{i 2 = 1}^{I} 〈 {X}_{i 1}^{m} , {X}_{i 2}^{n} 〉 ) , or \qquad ( 1 a )$$

$${k}_{set} ( {X}^{m} , {X}^{n} ) = \frac{1}{\vert {X}^{m} \vert \vert {X}^{n} \vert} {\sum }_{i 1 = 1}^{I} {\sum }_{i 2 = 1}^{I} k ( \vert {X}_{i 1}^{m} - {X}_{i 2}^{n} \vert ) ) , \qquad ( 1 b )$$

where |⋅|⋅,⋅<,>, and k (⋅) denote, respectively, the vector 2-norm, the inner product, and the Matérn kernel. It may be seen that Eq. (1) involves a summation, which implies the average of individual distances, so Eq. (1) may be referred to as the averaged set kernel. This is distinguishable from the other metric described next. The difference between Eq. (1a) and Eq. (1b) is that the Matérn kernel, k, is applied after or before the summation. It is noted that experiments utilizing Eq. (1a) show either similar or slightly better performance.

Alternatively, the Hausdorff distance may also be adopted, which is known for measuring the proximity between two subsets of a metric space. The covariance matrix then becomes:

$${k}_{set} ( {X}^{m} , {X}^{n} ) = k ( max \{ {sup}_{{x}_{i} ∈ {X}^{m}} {inf}_{{x}_{j} ∈ {X}^{n}} 〈 {x}_{i} , {x}_{j} 〉 , {sup}_{{x}_{j} ∈ {X}^{n}} {inf}_{{x}_{i} ∈ {X}^{m}} 〈 {x}_{i} , {x}_{j} 〉 \} . \qquad ( 2 )$$

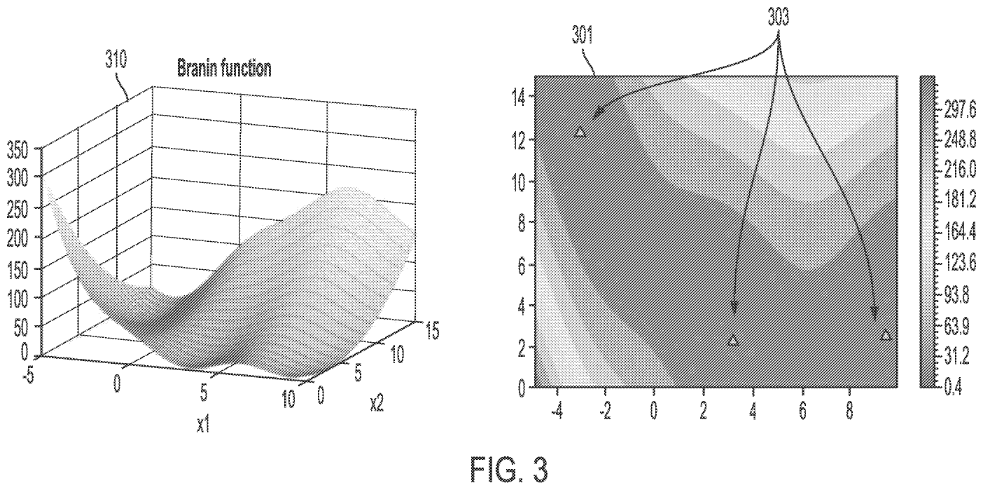

Consider a toy example of a non-convex function optimization formulated first. The differences between the toy problem and an actual TO problem will then be highlighted. FIG. 3 shows the test function known as the Branin function,

$$f ( x ) = {a ( {x}_{2} - {bx}_{1}^{2} + {cx}_{1} - r )}^{2} + s ( 1 - t ) cos ( {x}_{1} ) + s$$

$$a = 1 , b = 5.1 / ( 4 {π}^{2} ) , c = 5 / π , r = 6 , s = 10 , t = 1 / ( 8 π ) , and \\ {x}_{1} ∈ [ - 5 , 10 ] , {x}_{2} ∈ [ 0 , 15 ]$$

There are three global minimizers at (−π, 12.275), (π, 2.275), (9.42478, 2.475) with the value of 0.397887. To solve this problem by Bayesian optimization using sets of discrete values, each dimension is discretized, and tuples of these values are considered, which form a set. Therefore,

$${X}_{1} = \{ {x}_{{1}_{i}} \vert {x}_{{1}_{i}} ∈ ( - 5 , 10 ) , i = 1 , … , p \} , and \\ {X}_{2} = \{ {x}_{{2}_{j}} \vert {x}_{{2}_{j}} ∈ ( 0 , 15 ) , j = 1 , … , q \}$$

Xₛₑₜ is created by taking tuples of values from X₁, X₂.

Therefore,

$${X}_{set} = \{ {\{ [ {x}_{{1}_{i}} , {x}_{{2}_{j}} ] \}}_{m} \vert {x}_{{1}_{i}} ∈ {X}_{1} , {x}_{{2}_{j}} ∈ {X}_{2} , m = 1 , … , p \times q \}$$

For example, Xₛₑₜ={[1.1,3.4]}, {[−3.1,11.5]}, {[−4.7,12]}, . . . . In this example, p=q=150.

Starting with 10 data points randomly sampled from Xₛₑₜ to fit the initial Gaussian prior, i.e., covariance function (the data are generally offset to zero mean). In this example, each data point refers to the Branin function value at one location in the domain (of the independent variables). The Matérn kernel is chosen, which provides better performance to construct the covariance matrices.

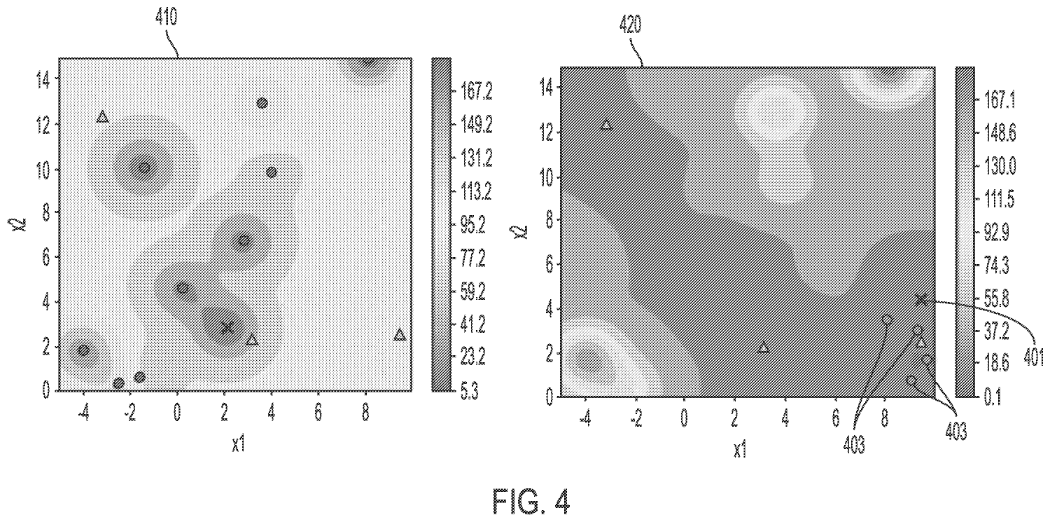

The GP fitting for the initial 10 points and after 30 BO iterations are shown in FIG. 4. Comparing with the contour plot 310 of FIG. 3, it may be seen that GP approximation to the true function improves significantly from using just 10 initial random points 410 to 30 more points after the BO iterations 430. The cross 401 and the dots 403 on the right of FIG. 4 show, respectively, the last and last few points suggested by expected improvement. As discussed earlier, EI attempts to optimize the trade-off between local and global searches.

Note here that the Branin function is smooth and has a well-defined domain in the Cartesian coordinate where the distance between any two points precisely represents their proximity.

BO is now applied over sets as explained in the previous sections to two use cases described here in detail.

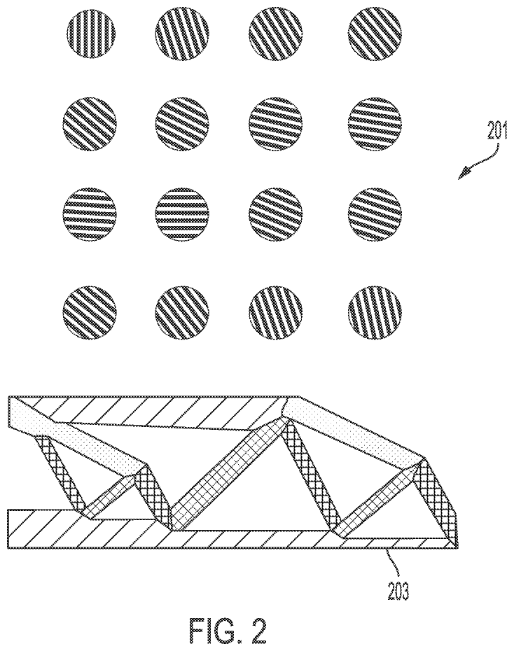

First, referring to FIG. 2, a library of sixteen 2d laminated lattice kernels is designed 201, whose geometric structures are offset by a particular angle. The goal is to select the best 4 lattice kernels as the inputs to the TO module for a 2d MBB beam problem. There are a total of 1820 possible set selections. For this 2d problem, it is computationally feasible to do exhaustive trials, so the minimum and maximum objective function values are obtained as 2.4473 and 12.6508, respectively. For BO experiments, 10 random initial sets are used to test how BO would perform for 50 iterations. In order to evaluate the BO performance with different initial sets, 1000 BO runs are performed.

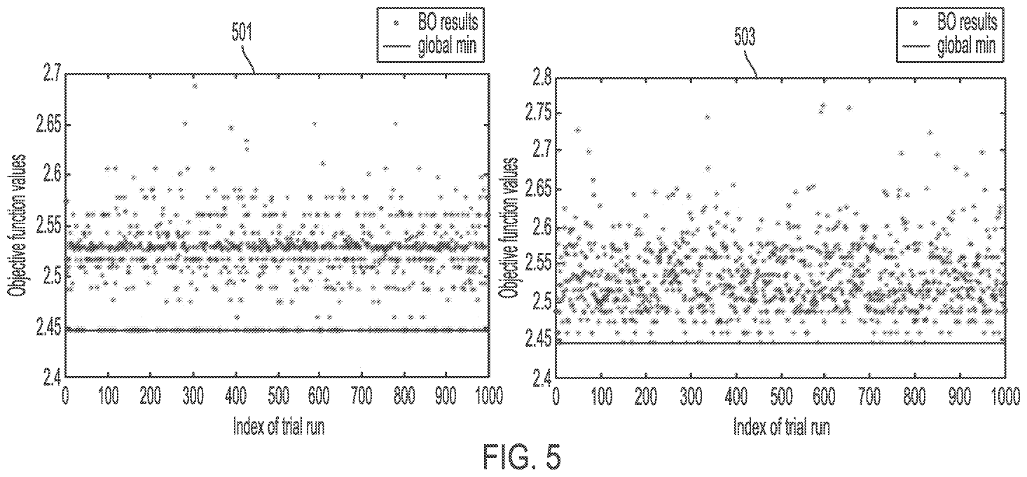

FIG. 5 shows the distributions of the achieved minima for 1000 BO runs using the averaged set kernel Eq. (1a) 501 and the Hausdorff distance Eq. (2) 503. The root mean squared errors (RMSE) are, respectively, 0.0813 (3.32%) and 0.0989 (4.04%). The maximal errors are, respectively, 0.2413 (9.86%) and 0.3160 (12.91%). This compares favorably with the errors when 60 random TO evaluations are performed.

The resulting structure with the optimal lattice kernels at angles 24°, 68, 90°, 134°, is shown as 203 of FIG. 2.

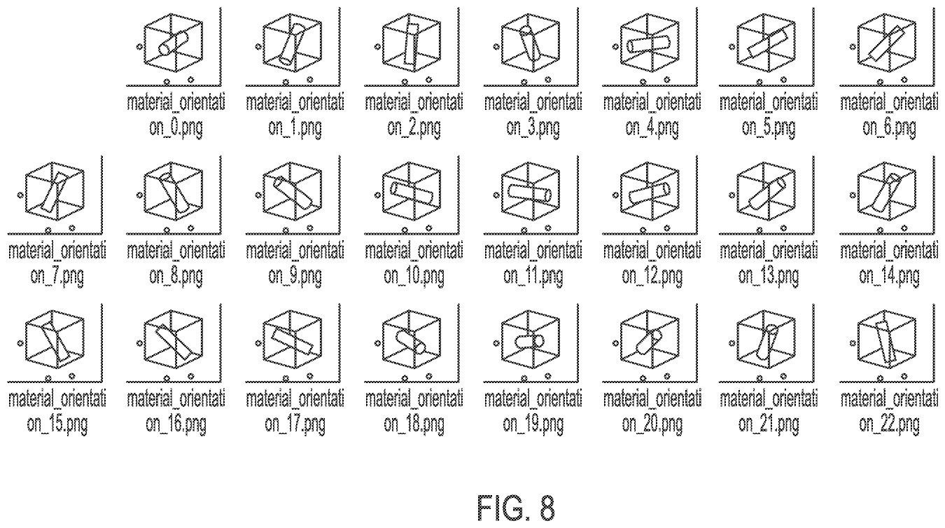

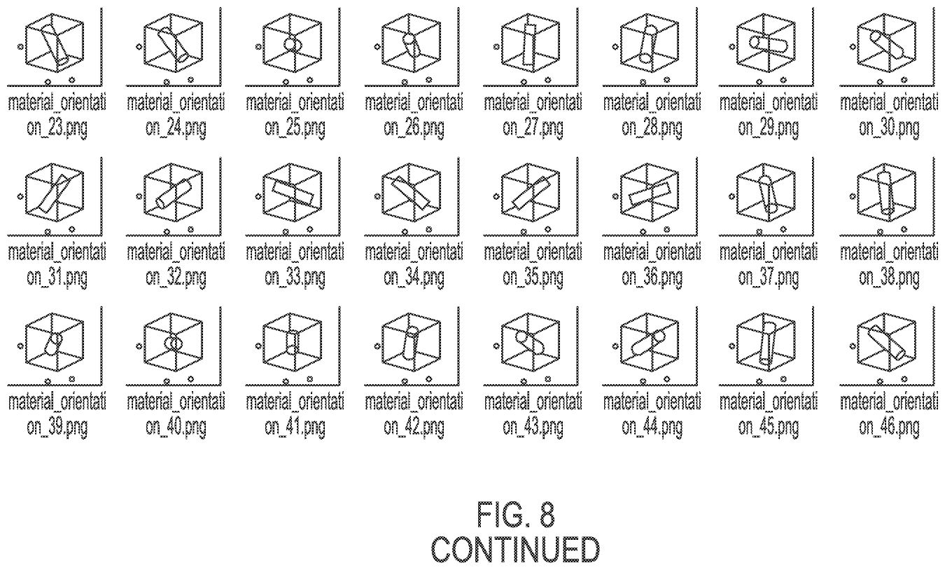

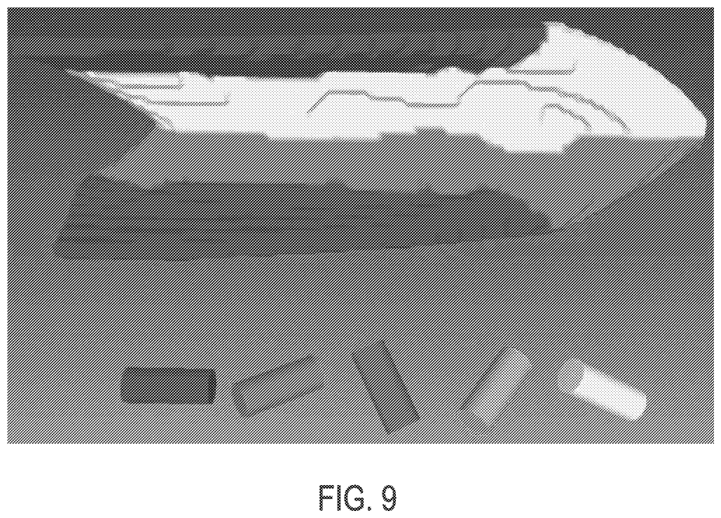

For the second use case, consider the 3d cantilever beam problem using a virtual forty-nine 3d oriented lattice library, whose shapes and orientations is shown in FIG. 8. The goal is to select 5 optimal kernels to form the structure of a cantilever beam. There are a total of 1,906,884 possible choices. Each TO evaluation for a 5-lattice kernel set takes around 100 minutes, so it is computationally infeasible for exhaustive trials. Accordingly, no ground truth is available. Nevertheless, FIG. 9 shows the resulting color-coded structure and the selected lattice kernels. It may be observed that the orientations of the selected lattice kernels aligned well with the load which is from the tip (right hand side in FIG. 9) of the cantilever beam. It may be assumed that the BO has achieved qualitatively good selection from nearly 2 million possible candidates.

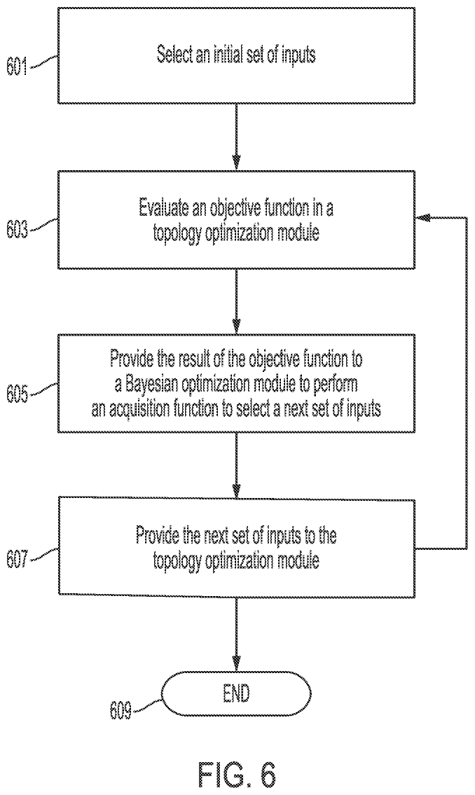

FIG. 6 is a process flow diagram for a method of exploring a design space according to aspects of embodiments of this disclosure. From a large plurality of possible inputs, an initial set of inputs is selected for evaluation 601. Using an objective function in a topology optimization module, the initial set of inputs are evaluated to calculate a result of the objective function 603. The calculated result is provided to a Bayesian optimization module, which uses an acquisition function and the result of the objective function to select a new set of inputs 605. The newly selected set of inputs is then provided to the topology optimization module to evaluate the new set of inputs 607.

The process of performing the Bayesian optimization is an iterative process that may be repeated for a predetermined number of times. When the Bayesian optimization has performed the pre-determined number of iterations, the process ends 609.

In summary, this proposed system will enable the realization of complex structures through optimal use of non-uniform non-identical lattices. These structures afford very high specific strength and enable engineered material properties. This expands the design space by relaxing the coupling between weight and strength.

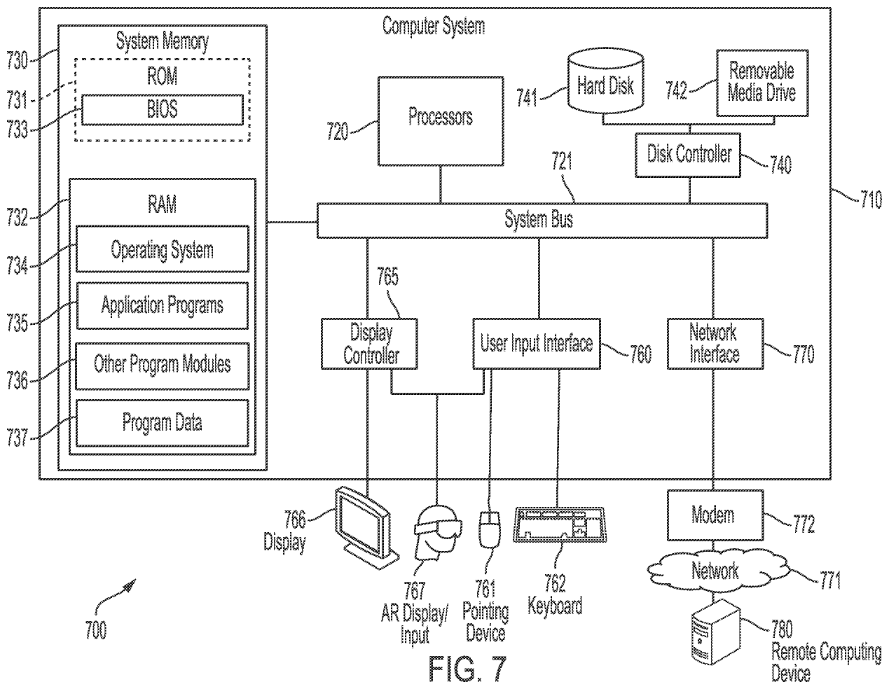

FIG. 7 illustrates an exemplary computing environment 700 within which embodiments of the invention may be implemented. Computers and computing environments, such as computer system 710 and computing environment 700, are known to those of skill in the art and thus are described briefly here.

As shown in FIG. 7, the computer system 710 may include a communication mechanism such as a system bus 721 or other communication mechanism for communicating information within the computer system 710. The computer system 710 further includes one or more processors 720 coupled with the system bus 721 for processing the information.

The processors 720 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting, or transmitting information for use by an executable procedure or an information device, and/or by routing the information to an output device. A processor may use or comprise the capabilities of a computer, controller, or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 7, the computer system 710 also includes a system memory 730 coupled to the system bus 721 for storing information and instructions to be executed by processors 720. The system memory 730 may include computer readable storage media in the form of volatile and/or nonvolatile memory, such as read only memory (ROM) 731 and/or random-access memory (RAM) 732. The RAM 732 may include other dynamic storage device(s) (e.g., dynamic RAM, static RAM, and synchronous DRAM). The ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in the ROM 731. RAM 732 may contain data and/or program modules that are immediately accessible to and/or presently being operated on by the processors 720. System memory 730 may additionally include, for example, operating system 734, application programs 735, other program modules 736 and program data 737.

The computer system 710 also includes a disk controller 740 coupled to the system bus 721 to control one or more storage devices for storing information and instructions, such as a magnetic hard disk 741 and a removable media drive 742 (e.g., floppy disk drive, compact disc drive, tape drive, and/or solid-state drive). Storage devices may be added to the computer system 710 using an appropriate device interface (e.g., a small computer system interface (SCSI), integrated device electronics (IDE), Universal Serial Bus (USB), or FireWire).

The computer system 710 may also include a display controller 765 coupled to the system bus 721 to control a display or monitor 766, such as a cathode ray tube (CRT) or liquid crystal display (LCD), for displaying information to a computer user. The computer system includes an input interface 760 and one or more input devices, such as a keyboard 762 and a pointing device 761, for interacting with a computer user and providing information to the processors 720. The pointing device 761, for example, may be a mouse, a light pen, a trackball, or a pointing stick for communicating direction information and command selections to the processors 720 and for controlling cursor movement on the display 766. The display 766 may provide a touch screen interface which allows input to supplement or replace the communication of direction information and command selections by the pointing device 761. In some embodiments, an augmented reality device 767 that is wearable by a user, may provide input/output functionality allowing a user to interact with both a physical and virtual world. The augmented reality device 767 is in communication with the display controller 765 and the user input interface 760 allowing a user to interact with virtual items generated in the augmented reality device 767 by the display controller 765. The user may also provide gestures that are detected by the augmented reality device 767 and transmitted to the user input interface 760 as input signals.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium, such as a magnetic hard disk 741 or a removable media drive 742. The magnetic hard disk 741 may contain one or more datastores and data files used by embodiments of the present invention. Datastore contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments of the invention and for containing data structures, tables, records, or other data described herein. The term “computer readable medium” as used herein refers to any medium that participates in providing instructions to the processors 720 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 741 or removable media drive 742. Non-limiting examples of volatile media include dynamic memory, such as system memory 730. Non-limiting examples of transmission media include coaxial cables, copper wire, and fiber optics, including the wires that make up the system bus 721. Transmission media may also take the form of acoustic or light waves, such as those generated during radio wave and infrared data communications.

The computing environment 700 may further include the computer system 710 operating in a networked environment using logical connections to one or more remote computers, such as remote computing device 780. Remote computing device 780 may be a personal computer (laptop or desktop), a mobile device, a server, a router, a network PC, a peer device, or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing device 780). The network 771 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite, or any other wireless connection methodology generally known in the art. Additionally, several networks may work alone or in communication with each other to facilitate communication in the network 771.

An executable application, as used herein, comprises code or machine-readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

What is claimed is:

1. A method of optimizing a process having a plurality of potential inputs, comprising:
selecting a first set of inputs from the plurality of potential inputs;
providing the first set of inputs from the to a first optimization process;
running an objective function on the first set of inputs to produce a value corresponding to the set of inputs;
providing the value to a second optimization process;
running an acquisition function in the second optimization process to select a new candidate set of inputs from the plurality of potential inputs; and
providing the selected new candidate set of inputs to the first optimization process.

2. The method of claim 1, wherein the first optimization process is a topology optimization in a structural object design.

3. The method of claim 2, wherein the second optimization process is a Bayesian optimization.

4. The method of claim 3, wherein the plurality of potential inputs comprises a set of lattice kernels.

5. The method of claim 4 further comprising:
generating the set of lattice kernels using design by programming (DBP).

6. The method of claim 3, wherein the acquisition function is an expected improvement function.

7. The method of claim 3, wherein the plurality of potential inputs comprises a set of lattice kernels, wherein the set of lattice kernels is numerically homogenized to define a stiffness matrix for each lattice kernel.

8. The method of claim 3, further comprising:
in the Bayesian optimization, approximating a black box function to evaluate surrogate function values in a Gaussian process associated with the Bayesian optimization.

9. The method of claim 8, further comprising:
performing the Bayesian optimization iteratively, beginning with a first set of initial data points from the plurality of inputs to establish a prior for the Gaussian process and for each subsequent iteration:
evaluating an acquisition function to select a next set of data points from the plurality of inputs, the acquisition function being an expected improvement function where:
$$EI ( x ) = {E}_{max} ( f ( x ) - f ( {x}^{+} ) , 0 ) , {x}^{+} = arg {max}_{x} \{ f ( x ) \} .$$

10. The method of claim 8, further comprising:
updating a covariance matrix of the Gaussian process based on the result of the objective function.

11. The method of claim 8, further comprising:
adding noise to the black box function in the Bayesian optimization.

12. The method of claim 4 further comprising:
constructing a lattice space via a vectorized representation of each lattice kernel as a stiffness matrix.

13. The method of claim 10, wherein the covariance matrix contains elements the represent a distance between two sets of lattice kernels.

14. The method of claim 13, wherein the elements of the covariance matrix are calculated according to an average of individual distances between elements of the sets of lattice kernels.

15. The method of claim 14, wherein the average of individual distances is calculated according to:
$${k}_{set} ( {X}^{m} , {X}^{n} ) = k ( \frac{1}{\vert {X}^{m} \vert \vert {X}^{n} \vert} {\sum }_{i 1 = 1}^{I} {\sum }_{i 2 = 1}^{I} 〈 {X}_{i 1}^{m} , {X}_{i 2}^{n} 〉 )$$

16. The method of claim 13, wherein the elements of the covariance matrix are calculated according to a Hausdorff distance.

17. The method of claim 16, the Hausdorff distance calculated according to:
$${k}_{set} ( {X}^{m} , {X}^{n} ) = k ( max \{ {sup}_{{x}_{i} ∈ {X}^{m}} {inf}_{{x}_{j} ∈ {X}^{n}} 〈 {x}_{i} , {x}_{j} 〉 , {sup}_{{x}_{j} ∈ {X}^{n}} {inf}_{{x}_{i} ∈ {X}^{m}} 〈 {x}_{i} , {x}_{j} 〉 \} .$$

18. A computer-based system for optimizing a process having a plurality of potential inputs, comprising:
a computer processor in communication with a non-transitory computer memory, the non-transitory computer memory storing instructions that when executed by the computer processor causes the computer processor to:
select a first set of inputs from the plurality of potential inputs;
provide the first set of inputs from the to a first optimization process;
run an objective function on the first set of inputs to produce a value corresponding to the set of inputs;
provide the value to a second optimization process;
run an acquisition function in the second optimization process to select a new candidate set of inputs from the plurality of potential inputs; and
provide the selected new candidate set of inputs to the first optimization process.

19. The method of claim 18, comprising a topology optimization module for performing the first optimization process.

20. The method of claim 18, comprising a Bayesian optimization module for performing the second optimization process.
